(19) United States
(12) Patent Application Publication
(10) Pub. No.: US 2017/0300294 A1
(43) Pub. Date: Oct. 19, 2017

(54) AUDIO ASSISTANCE METHOD FOR A CONTROL INTERFACE OF A TERMINAL, PROGRAM AND TERMINAL

(71) Applicant: ORANGE, Paris (FR)

(72) Inventors: Valérie Botherel, Mantallot (FR); Stéphane Louis Dit Picard, Le Rheu (FR); Danielle Le Razavet, Lannion (FR)

(21) Appl. No.: 15/489,641

(22) Filed: Apr. 17, 2017

(30) Foreign Application Priority Data
Apr. 18, 2016 (FR) 1653414

(51) Int. Cl. G06F 3/16; G06F 3/0481

(52) U.S. Cl. CPC G06F 3/167; G06F 3/0481

(57) ABSTRACT

An audio assistance method for a control interface of a terminal, a program and a terminal are disclosed. In particular, the audio assistance is provided for a control interface for a process implemented by the terminal. In one embodiment, an audio assistance method for a control interface of a terminal is disclosed, the audio assistance method comprising, following the triggering of execution, by the terminal, of a process activating a control interface allowing a user of the terminal to interact with the executed process, providing the active control interface with an assistance activation controller allowing the user of the terminal to activate audio assistance adapted to the active control interface. The risk of interaction error is reduced because the user can more easily activate the audio assistance since he does not need to return to the settings of the system of the terminal in order to activate the audio assistance.

### BACKGROUND

### Field

The field relates to an audio assistance method for a control interface of a terminal, a program and a terminal. In particular, the audio assistance is provided for a control interface for a process implemented by the terminal.

### Description of the Related Art

Audio elements are currently integrated into interfaces on a terminal such as a computer or a smartphone by associating an audio element with a function. The integration allows the user to be provided with a piece of audio information on a state of the service, an audio notification from the service, or audio feedback on an action of the user relative to the service.

Audio elements are available in the office environment, such as Windows, regardless of the system or operating system (OS) (particularly iOS, Android, etc.). The audio elements are then associated with actions of the user. This means that the audio elements are triggered by an action of the user and therefore extended by the user after an action on his part on the interface of the terminal. This is therefore audio feedback on the action performed, such as, by way of example, the crumpled paper sound heard after having requested the deletion of a file.

In order to activate, deactivate or modify these audio elements (voice synthesis, audio events), the user of the terminal needs to open the system settings window (iOS, Android, etc.) of the terminal.

There are also solutions for blind or partially-sighted people using methods such as TalkBack on Android or VoiceOver on IOS, etc. These environments dedicated to blind or partially-sighted people generate the voice synthesis in order to allow the user to explore the whole interface and to hear by voice the information contained on the screen in order to be able to select the desired actions.

In order to easily allow the user to access voice assistance, the simple actions of selection (mouse click, touch tap, etc.) and scrolling (dragging using a finger, movement of the mouse, etc.) are reserved for voice assistance. Therefore, in these specific voice assistance environments, the conventional scrolling rules proposed by the interfaces are changed. Exploration is effected by shifting the focus, and scrolling on several pages (that is to say beyond the area visible on the screen) is effected no longer by simply dragging a finger but rather by a dedicated gesture unknown to the general public such as dragging three (3) fingers simultaneously in contact with the screen. The user of the terminal implementing this voice assistance then has to learn the interaction standards specific to this environment with risks of error in the services provided that are linked to erroneous manipulations or to a manipulation taking place after a period of time greater than a timeout provided by an interface when it is displayed.

Moreover, in order to activate/deactivate this voice assistance environment, the user of the terminal must go into the accessibility settings of the terminal.

One of the aims of the present disclosure is to make improvements over the prior art.

### SUMMARY

One subject of the present disclosure is an audio assistance method for a control interface of a terminal, the audio assistance method comprising, following the triggering of execution, by the terminal, of a process activating a control interface allowing a user of the terminal to interact with the executed process, providing the active control interface with an assistance activation controller allowing the user of the terminal to activate audio assistance adapted to the active control interface.

Thus, the risk of interaction error is reduced because the user can more easily activate the audio assistance since the user need not return to the settings of the system of the terminal in order to activate the audio assistance.

Advantageously, the audio assistance method comprises, following activation of audio assistance of an active control interface for a process executed by the terminal, providing an active interface for the executed process with an assistance deactivation controller allowing the user of the terminal to deactivate the audio assistance of the control interface for the executed process.

Thus, the risk of interaction error is reduced because the user can more easily deactivate the audio assistance since the user need not return to the settings of the system of the terminal in order to deactivate the audio assistance.

Moreover, the audio assistance interface for a process does not need to provide specific controllers for triggering the execution of the subprocesses of the process since the user easily toggles from the control interface for a process to the audio assistance interface for the process.

Advantageously, the audio assistance method comprises, following activation of audio assistance, replacing, solely and at least for one of the selection controllers of the active control interface, triggering of execution of a subprocess associated with the selection controller of the active control interface with triggering of audio reproduction of descriptive data relating to the subprocess associated with the selection controller.

Thus, the audio assistance is provided not on a single page of the control interface for the process but rather on all of its pages when it has several and without the need to add a specific scrolling controller for the audio assistance interface.

Advantageously, the audio assistance method comprises generation of an audio assistance interface from a modification solely of the selection controllers of the active control interface.

Thus, the audio assistance interface is generated not for a single page of the control interface for the process but rather for all of its pages when it has several and without the need to add a specific scrolling controller for the audio assistance interface.

Advantageously, the generation of an audio assistance interface for a control interface for a process is triggered as soon as at least one of the following events occurs:
activation of audio assistance from a control interface for a process;
installation of the audio assistance method on the terminal;
installation of a process on the terminal;
update of a process on the terminal.

Thus, the triggering of the generation of an audio assistance interface on activation of audio assistance from a control interface limits the generation of audio assistance interfaces solely to those used.

At the same time, the triggering of the generation of an audio assistance interface following installation of the audio assistance method and/or of a process and/or of an update to a process on the terminal allows a reduction in the time for implementing the audio assistance when it is activated.

Advantageously, the generation of the audio assistance interface comprises storing in the terminal, in association with the process, the generated audio assistance interface, allowing subsequent activation of the audio assistance for the control interface for the process to trigger the implementation of the audio assistance interface stored in association with the process.

Thus, the storage of an audio assistance interface that has already been generated allows a reduction in the time for implementing the audio assistance when it is activated. Moreover, this reduction in the time is possible while reducing the use of resources when generation is triggered solely on activation of the audio assistance. The reason is that first activation of audio assistance triggers the generation of an audio assistance interface solely for this process limiting the number of audio assistance interfaces generated and stored relative to the number of processes available on the terminal. The storage of this audio assistance interface generated at the time of first activation allows it to be used without a generation delay on subsequent activations.

Advantageously, the audio assistance method comprises activation of the audio assistance at the command of a user of the terminal triggering reproduction of an audio assistance interface for the process being executed, the audio assistance interface having been generated from a modification solely of the selection controllers of the active control interface.

Thus, the user controls the reproduction of an interface specific to the audio assistance that is a true copy of the interface for which the assistance is provided facilitating the learning of the control interface by means of the audio assistance.

Advantageously, the audio assistance method comprises activation of the audio assistance at the command of a user of the terminal triggering reproduction of an audio assistance interface superposed on the reproduced active control interface, the audio assistance interface having been generated from a modification solely of the selection controllers of the active control interface.

Thus, the user controls the reproduction superposed on an interface specific to the audio assistance that is a true copy of the interface for which the assistance is provided facilitating the learning of the control interface by means of the audio assistance not only because of the true copy but also because of the superposition allowing the user to familiarize himself with the control interface.

Advantageously, the control interface is at least one of the following types:
a graphical interface, and
a touch interface.

Another subject of the present disclosure is a processing method capable of being executed by a terminal, the processing method comprising activation of a control interface of a terminal allowing a user of the terminal to interact with the executed processing method, and, following the triggering of execution of the processing method by the terminal, providing the active control interface with an activation controller for audio assistance allowing the user of the terminal to activate audio assistance adapted to the active control interface.

Advantageously, according to one implementation of the present disclosure, the various steps of the method according to the present disclosure are implemented by a piece of software or a computer program, this software comprising software instructions intended to be executed by a data processor of a device forming part of a terminal, and being designed to control the execution of the various steps of this method.

The present disclosure is thus also aimed at a program comprising program code instructions for executing the steps of the audio assistance method and/or of the processing method when the program is executed by a processor.

This program can use any programming language and be in the form of source code, object code or an intermediate code between source code and object code such as in a partially compiled form or in any other desirable form.

One subject of the present disclosure is also a terminal having:
a processor executing at least one process;
at least one control interface for one of the at least one process; and
an audio assistant for a control interface, the audio assistance providing, following the triggering of execution, by the terminal, of a process activating a control interface allowing a user of the terminal to interact with the executed process, the active control interface with an assistance activation controller allowing the user of the terminal to activate audio assistance adapted to the active control interface.

### BRIEF DESCRIPTION OF THE DRAWINGS

The features and advantages of the present disclosure will emerge more clearly on reading the description, provided by way of example, and the figures relating thereto, in which:

FIGS. 1a and 1b are schematic diagrams of an audio assistance method for a control interface of a terminal, according to one embodiment, respectively provided or otherwise by means of an audio assistance interface according to the present disclosure;

FIGS. 2a and 2b are schematic diagrams of the exchanges in a terminal implementing an embodiment disclosed herein, respectively on start-up of the execution of a process by the terminal, on activation of the audio assistant for FIG. 2a, and when the audio assistant is active, on and after stoppage of the audio assistant for FIG. 2b;

FIG. 3 is a schematic diagram of a terminal having an audio assistant according to various embodiments;

FIGS. 4a, 4b and 4c illustrate examples of audio assistance interfaces according to various embodiments, respectively for a process of application type for a smartphone for FIG. 4a, and for FIG. 4b, for an internet page displayed by a browser on a tablet or a computer.

### DETAILED DESCRIPTION

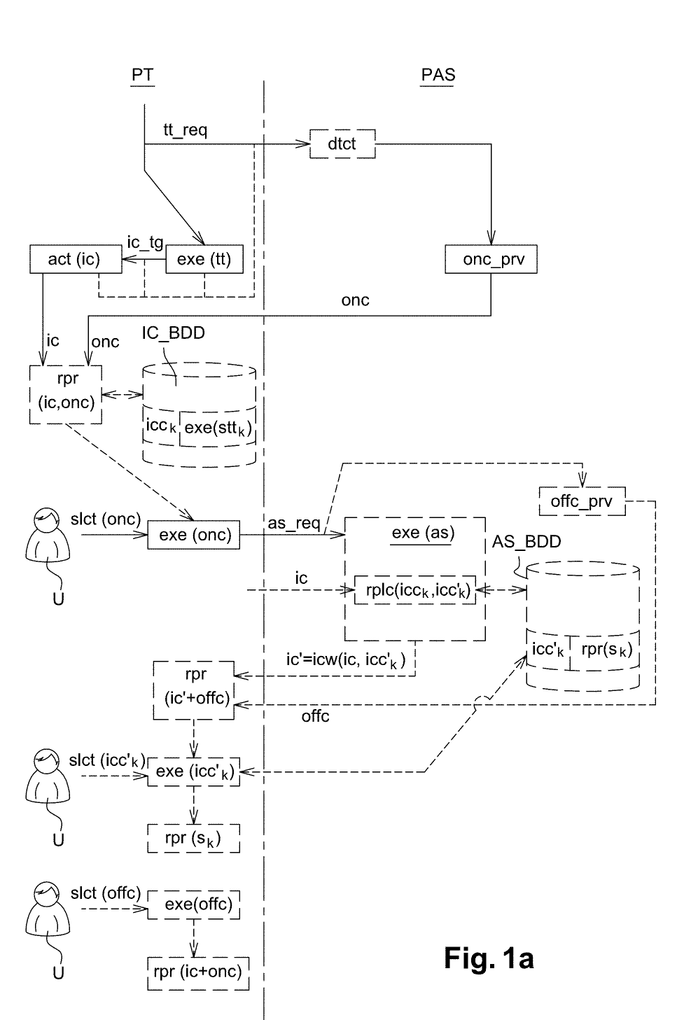

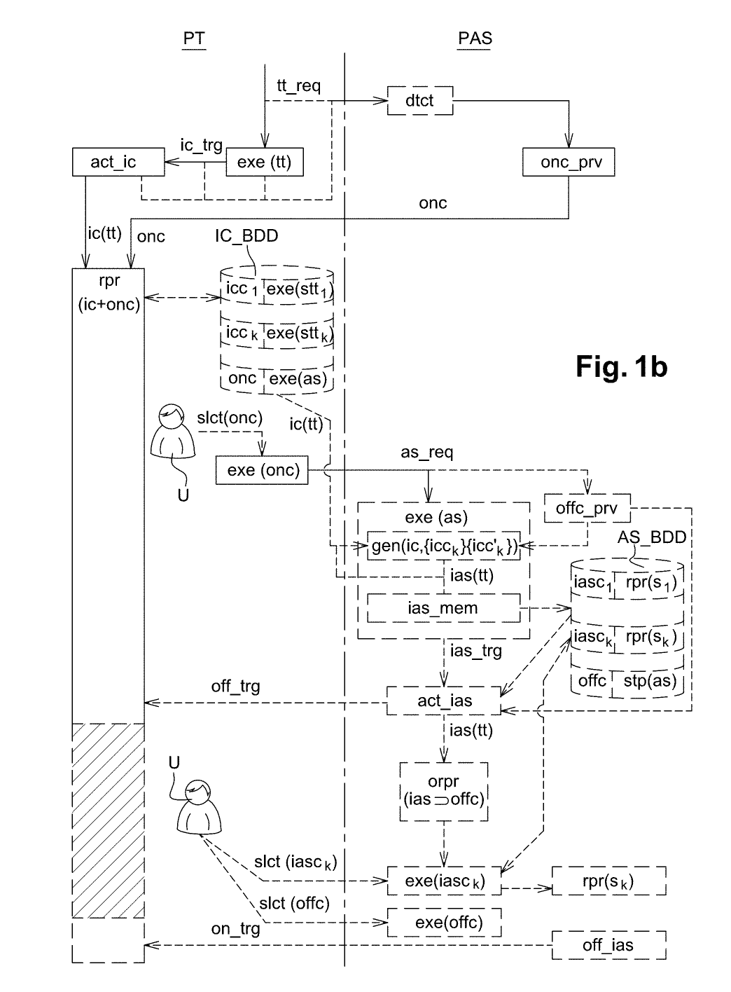

FIGS. 1a and 1b illustrate simplified diagrams of an audio assistance method PAS for a control interface of a terminal, according to one embodiment. FIG. 1a illustrates a simplified diagram of an audio assistance method PAS for a control interface of a terminal in which the audio assistance is provided on the control interface.

The audio assistance method PAS comprises, following the triggering tt_req of execution exe(tt), by the terminal, of a process activating act(ic) a control interface allowing a user of the terminal to interact with the executed process, providing onc_prv the active control interface with an assistance activation controller one allowing the user of the terminal to activate audio assistance adapted to the active control interface.

In particular, the audio assistance method PAS comprises, following activation of audio assistance as_req of an active control interface for a process executed by the terminal, providing offc_prv an active interface for the executed process with an assistance deactivation controller offc allowing the user of the terminal to deactivate the audio assistance of the control interface for the executed process.

In particular, the audio assistance method PAS comprises, following activation of audio assistance, replacing rplc(iccₖ,icc′ₖ), solely and at least for one of the selection controllers of the active control interface iccₖ, triggering of execution of a subprocess associated exe(sttₖ) with the selection controller iccₖ of the active control interface with triggering of audio reproduction of descriptive data rpr(sₖ) relating to the subprocess associated with the selection controller iccₖ.

In particular, the control interface ic is at least one of the following types:
a graphical interface (graphical interface, also called visual interface, is understood to mean a readable interface such as a displayable interface), and
a touch interface.

The audio assistance method PAS according to the present disclosure is proposed for at least one processing method PT capable of being executed by a terminal, the processing method PT comprising activation act(ic) of a control interface of a terminal allowing a user of the terminal to interact with the executed processing method.

In particular, a processing method PT comprises execution of a process exe(tt) following a start-up request for the process tt_req from particularly a control interface of the terminal. A user U particularly requests execution of the process by selecting a selection controller of the control interface of the terminal associated with the triggering of the execution of the process.

If the executed process tt requires an interaction with the user, the execution of the process exe(tt) triggers ic_trg, possibly, activation of a control interface specific to the process act(ic).

In particular, the process request tt_req or the execution of the process exe(tt) or the triggering of the activation of the control interface ic_trg or the activation of the control interface act(ic) directly or indirectly triggers the provision of the audio assistance activation controller to the control interface onc-prv.

In particular, the audio assistance method PAS comprises detection dtct of triggering of the execution, by the terminal, of a process activating a control interface allowing a user of the terminal to interact with the executed process. In particular, the detection detects either one of the request signals for process tt_req or triggering of the activation of the control interface is_trg, or the execution of the process exe(tt) or the activation of the control interface act(ic).

In particular, a processing method PT according to the present disclosure comprises one or more of the steps of the audio assistance method PAS. In particular, the processing method PT according to the present disclosure comprises, following the triggering tt_req of execution, by the terminal, of the processing method, providing onc_prv the active control interface with an activation controller for audio assistance allowing the user of the terminal to activate audio assistance adapted to the active control interface. If the audio assistance method comprises detection dtct, then the assistance activation control onc is provided to the detected active control interface.

Thus, the processing method PT provides a control interface rpr(ic+onc) for the process having an audio assistance activation controller. The provision of the control interface for the process comprises the association of one or more controllers of a control interface of a terminal (pushbutton, area of a screen, etc.) with the execution of subprocess(es) of the executed process and, in particular, the reproduction of the control interface for the process on a screen in the case of a graphical and/or touch interface.

In particular, the provision of the control interface for a process repr(ic+onc) uses a control interface database IC_BDD that stores each association of a controller of a control interface of a terminal for a given process iccₖ with the execution of subprocess(es) of the given process exe(sttₖ).

In particular, if the control interface is a graphical interface, the activation controller is an area of the graphical interface, a pushbutton of the terminal, etc., associated with the activation of the audio assistance. In the case of the area of the graphical interface, a text will possibly be displayed on this area allowing the user of the terminal to understand that selection of this area is associated with the activation of the audio assistance. The area or the button associated with the activation is, by way of example, chosen in a corner of the control interface in order to facilitate access thereto for the (in particular partially sighted) user.

In particular, the audio assistance method PAS comprises activation of audio assistance exe(as) adapted to the active control interface at the command of the activation controller one provided by a user of the terminal. In particular, a user U of the terminal executing a process requests the activation of the audio assistance by selecting the activation controller slct(onc).

In particular, the processing method comprises, following this request slct(onc), executing the controller exe(onc) triggering as_req the activation of the audio assistance, particularly the execution of the audio assistance exe(as).

In particular, the execution of the audio assistance exe(as) comprises particularly replacing rplc, in at least one selection controller iccₖ of the active control interface, the execution of an associated subprocess exe(sttₖ) with an audio reproduction of a descriptor of the associated subprocess rpr(sₖ). This new association is particularly stored in an assistance database AS_BDD.

In particular, in the case of a graphical interface, the replacement rplc in a controller iccₖ moreover comprises adding graphical data dgₖ to the graphical data dgₖ associated with the controller icc′ₖ modified by this replacement. Thus, the modified graphical data (dgₖ,dg⁺ₖ) reproduced on the control interface ic′ modified by the audio assistance at the time of the replacement rplc allow the user to identify the controller(s) for which audio assistance is provided.

In particular, the execution of the audio assistance provides the data of the control interface ic′ modified by this replacement so that the modified control interface is activated and offered to the user U of the terminal.

In particular, the audio assistance method PAS comprises, following activation of audio assistance as_req, providing offc_prv an active interface, in this case the modified control interface for the executed process ic′, with an assistance deactivation controller offc.

Then, the processing method PT comprises providing rpr(ic′+offc) the modified control interface ic′ integrating the deactivation controller offc.

In particular, a user wanting audio assistance relating to a controller iccₖ of the control interface selects the corresponding controller slct(icc′ₖ) on the modified control interface provided ic′. This selection slct(icc′ₖ) brings about execution of the modified controller exe(icc′ₖ) by the processing method PT that triggers the audio reproduction of the descriptor of the subprocess associated with the controller rpr(sₖ). The audio reproduction of the descriptor is particularly a vocalization of the displayed descriptor or a sound associated with the subprocess (for example a sound of a coin rattling for a payment, crumpling of paper for a deletion, a “clink” for a creation, etc.).

In particular, the processing method and/or the audio assistance method comprises deactivation of the audio assistance exe(offc) at the command of the deactivation controller offc provided by a user of the terminal. In particular, a user U of the terminal executing a process requests deactivation of the audio assistance by selecting the activation controller slct(offc). The deactivation exe(offc) then triggers the provision of the control interface rpr(ic+onc) for the process having the audio assistance activation controller by the processing method PT.

The audio assistance method according to the present disclosure provides at least one controller allowing triggering of the activation or deactivation of audio assistance. If the audio assistance method provides, by way of example, a single controller having at least two states, then the triggering of activation or deactivation of the audio assistance is dependent on the state of the controller. By way of example, when the state of the controller changes from a deactivated state to an activated state or from a 0 state to a 1 state, etc., it triggers the activation of audio assistance. Conversely, when the state of the controller changes from an activated state to a deactivated state or from a 1 state to a 0 state, etc., it triggers the deactivation of the audio assistance.

FIG. 1b illustrates a simplified diagram of an audio assistance method for a control interface of a terminal in which the audio assistance is provided on a specific audio assistance interface according to various embodiments.

The audio assistance method PAS comprises, following the triggering tt_req of execution exe(tt), by the terminal, of a process activating act(ic) a control interface allowing a user of the terminal to interact with the executed process, providing onc_prv the active control interface with an assistance activation controller onc allowing the user of the terminal to activate audio assistance adapted to the active control interface.

In particular, the audio assistance method PAS comprises, following activation of audio assistance as_req of an active control interface for a process executed by the terminal, providing offc_prv an active interface for the executed process with an assistance deactivation controller offc allowing the user of the terminal to deactivate the audio assistance of the control interface for the executed process.

In particular, the audio assistance method PAS comprises, following activation of audio assistance, replacing rplc(iccₖ,icc′ₖ), solely and at least for one of the selection controllers of the active control interface iccₖ, triggering of execution of a subprocess associated exe(sttₖ) with the selection controller iccₖ of the active control interface with triggering of audio reproduction of descriptive data rpr(sₖ) relating to the subprocess associated with the selection controller iccₖ.

In particular, the control interface ic is at least one of the following types:
a touch interface,
a graphical interface.

The audio assistance method PAS according to the present disclosure is proposed for at least one processing method PT capable of being executed by a terminal, the processing method PT comprising activation act(ic) of a control interface of a terminal allowing a user of the terminal to interact with the executed processing method.

In particular, a processing method PT comprises execution of a process exe(tt) following a start-up request for the process tt_req from particularly a control interface of the terminal. A user U particularly requests execution of the process by selecting a selection controller of the control interface of the terminal associated with the triggering of the execution of the process.

If the executed process tt requires an interaction with the user, the execution of the process exe(tt) triggers is_trg, possibly, activation of a control interface specific to the process act(ic).

In particular, the process request tt_req or the execution of the process exe(tt) or the triggering of the activation of the control interface is_trg or the activation of the control interface act(ic) directly or indirectly triggers the provision of the audio assistance activation controller to the control interface one-prv.

In particular, the audio assistance method PAS comprises detection dtct of triggering of the execution, by the terminal, of a process activating a control interface allowing a user of the terminal to interact with the executed process. In particular, the detection detects either one of the request signals for process tt_req or triggering of the activation of the control interface is_trg, or the execution of the process exe(tt) or the activation of the control interface act(ic).

In particular, a processing method PT according to the present disclosure comprises one or more of the steps of the audio assistance method PAS. In particular, the processing method PT according to the present disclosure comprises, following the triggering tt_req of execution, by the terminal, of the processing method, providing onc_prv the active control interface with an activation controller for audio assistance allowing the user of the terminal to activate audio assistance adapted to the active control interface. If the audio assistance method comprises detection dtct, then the assistance activation control one is provided to the detected active control interface.

Thus, the processing method PT provides a control interface rpr(ic+onc) for the process having an audio assistance activation controller. The provision of the control interface for the process comprises the association of one or more controllers of a control interface of a terminal (pushbutton, area of a screen, etc.) with the execution of subprocess(es) of the executed process and, in particular, the reproduction of the control interface for the process on a screen in the case of a graphical and/or touch interface.

In particular, the provision of the control interface for a process repr(ic+onc) uses a control interface database IC_BDD that stores each association of a controller of a control interface of a terminal for a given process iccₖ with the execution of subprocess(es) of the given process exe(sttₖ).

In particular, if the control interface is a graphical interface, the activation controller is an area of the graphical interface, a pushbutton of the terminal, etc., associated with the activation of the audio assistance. In the case of the area of the graphical interface, a text will possibly be displayed on this area allowing the user of the terminal to understand that selection of this area is associated with the activation of the audio assistance. The area or the button associated with the activation is, by way of example, chosen in a corner of the control interface in order to facilitate access thereto for the (in particular partially sighted) user.

In particular, the audio assistance method PAS comprises activation of audio assistance exe(as) adapted to the active control interface at the command of the activation controller onc provided by a user of the terminal. In particular, a user U of the terminal executing a process requests the activation of the audio assistance by selecting the activation controller slct(onc).

In particular, the processing method comprises, following this request slct(onc), executing the controller exe(onc) triggering as_req the activation of the audio assistance, particularly the execution of the audio assistance exe(as).

In particular, the execution of the audio assistance exe(as) comprises particularly replacing rplc, in at least one selection controller iccₖ of the active control interface, the execution of an associated subprocess exe(sttₖ) with an audio reproduction of a descriptor of the associated subprocess rpr(sₖ). This new association is particularly stored in an assistance database AS_BDD.

In particular, the audio assistance method comprises generation gen(ic,{iccₖ},{icc′ₖ}) of an audio assistance interface ias(tt) from a modification solely of the selection controllers iccₖ of the active control interface.

In particular, the generation gen of an audio assistance interface for a control interface for a process ic is triggered as soon as at least one of the following events occurs:
activation as_req of audio assistance from a control interface for a process;
installation of the audio assistance method on the terminal (not illustrated);
installation of a process on the terminal (not illustrated);
update of a process on the terminal (not illustrated).

Indeed, the audio assistance interface, in particular, superposed on the control interface can be generated in different ways:

A first solution consists in precalculating all of the data of the audio assistance interface (particularly the association information of the selection controllers and the initiators of reproduction of descriptive data for associated subprocesses) from the control interface data (particularly the association information of the selection controllers and the initiators of execution of associated subprocesses). The audio assistance interface is generated a priori at the instant of generation of the control interface for the process. Thus, each processing device would have its own audio assistance device embedded when it is manufactured.

A second solution consists in generating a new audio assistance interface window on the fly from a rapid analysis of the displayed control interface window, specifically at the time of the execution of the process (in contrast to the preceding method, which involved generating the audio assistance interface at the time of the design of the processing method). This analysis runs through the hierarchy, particularly graphical, of the selection controllers for the window of the control interface in order to extract the controllers associated with audio reproduction of descriptive data or an audio event. From the final position of each controller in the control interface, a representation of the audio assistance interface is generated and displayed superimposed on the initial window of the control interface.

In particular, the generation gen of the audio assistance interface comprises storing ias_mem in the terminal, in association with the process, the generated audio assistance interface AS_BDD, allowing subsequent activation of the audio assistance for the control interface for the process to trigger the implementation of the audio assistance interface stored in association with the process.

In particular, the audio assistance method PAS comprises providing act_ias an audio assistance interface ias(tt) adapted to the process being executed. Possibly, the provision of the audio assistance interface act_ias is triggered by the activation of the audio assistance exe(as). The audio assistance interface is then active.

In particular, the audio assistance method PAS comprises reproduction of an audio assistance interface orpr(ias) for the process being executed, the audio assistance interface having been generated from a modification solely of the selection controllers of the active control interface. For example the activation of the audio assistance exe(as) triggers the reproduction of the audio assistance interface orpr(ias).

In particular, the audio assistance interface is reproduced orpr(ias) for the process being executed instead of the active control interface rpr(ic). By way of example, either the triggering ias_trg of the reproduction of the audio assistance interface orpr(ias) or the reproduction of the audio assistance interface orpr(ias) triggers stoppage of the provision of the control interface rpr(ic), in particular reproduction thereof. The control interface ic for the executed process is then inactive.

In particular, the audio assistance method PAS comprises reproduction of an audio assistance interface orpr(ias) superposed on the reproduced active control interface. Thus, the reproduced audio assistance interface is active, and the reproduced control interface under the audio assistance interface is also possibly active. In FIG. 1b, the reproduction rpr(ic+onc) of the control interface is hatched in order to show that the reproduced control interface can be deactivated during the reproduction of the audio assistance interface orpr(ias).

The user can thus easily toggle from the control interface to the assistance interface and vice versa avoiding the generation of a specific interface including the generation of new specific controllers for the audio assistance interface, therefore reducing the costs of generation calculations linked to the audio assistance and the resource needs particularly for audio assistance interface storage.

In particular, in the case of a graphical interface, the audio assistance interface ias is generated from the control interface ic(tt) in which the replacement rplc in a controller iccₖ moreover comprises adding graphical data dgₖ to the graphical data dgₖ associated with the controller iasc′ₖ modified by this replacement. Thus, the modified graphical data (dgₖ,dg⁺ₖ) reproduced on the control interface ic′ modified by the audio assistance at the time of the replacement rplc allow the user to identify the controller(s) for which audio assistance is provided.

Thus, a new window of the audio assistance interface displayed superposed on the initial window of the control interface and generated by one or other of the aforementioned methods contains:
the initial rules of interaction in the process that will allow a distinction between those concerning:
   the actions on a specific selection controller (or graphical element) whose execution is inhibited during the audio assistance;
   the actions that will allow movement in the control/audio assistance interface for the process (will allow scrolling) and that are kept as before during the audio assistance
and/or indicators of the selection controllers associated with an audio reproduction of descriptive data
and/or additional graphical data of the selection controllers on the audio assistance interface (contour of the selection controllers or halo or specific icon prompting the user to listen, etc.).

The notion of movement in the process or service refers to movements in the page or in the active interface for the process (control interface or audio assistance interface) through manipulation of an area of the window rather than of a selection controller generally corresponding to a precise cell/area of a graphical interface, the latter referring to a text element, a button or an icon, for example. The notion of movement makes it possible to reveal a portion of the active interface that is not visible by default (for example: access to elements in a list, to menus, functional thumbnails, particularly by touching a mobile terminal starting from one of its edges to the opposite side, etc.).

The window of the audio assistance interface superposed on the control interface window can be displayed in different forms according to the constraints:
a highly opaque veil allowing specific graphical data to be displayed;
an image superposed on the initial window showing only the controllers of selection associated with the sound, etc.

The window of the audio assistance interface superposed on the control interface window can display all or some of the selection controllers associated with an audio event. The display of a page of the audio assistance interface can be divided into multiple windows by making allowance for the architecture of the page. Each window displays a focus on specific selection controllers grouped, by way of example, by hierarchic display level (page header, paragraphs, subjects handled, movement arrows, selection button, etc.). The automatic activation of the scrolling of the windows corresponding to one and the same page will be possible by means of a double tap or double click or with a set timeout. The manual activation of the scrolling will be possible by means of a tap or click on the mask of the window (that is to say outside the selection controllers).

In particular, the execution of the audio assistance provides the data of the audio assistance interface ias(tt) so that the audio assistance interface is activated act_ias and offered orpr(ias) to the user U of the terminal. In particular, the execution of the audio assistance triggers ias_trg provision act_ias of the data of the audio assistance interface, which is then active.

In particular, the audio assistance method PAS comprises, following activation of audio assistance as_req, providing offc_prv the active interface, in this case the audio assistance interface ias, with an assistance deactivation controller offc.

Then, the audio assistance method PAS comprises providing orpr(ias⊃offc) the audio assistance interface ias integrating the deactivation controller offc.

In particular, a user wanting audio assistance relating to a controller iccₖ of the control interface selects the corresponding controller slct(iasck) on the audio assistance interface provided ias. This selection slct(iascₖ) brings about execution of the modified controller exe(iasc′ₖ) by the audio assistance method PAS that triggers the audio reproduction rpr(sₖ) of the descriptor of the subprocess associated with the controller.

In particular, the audio assistance method comprises deactivation of the audio assistance exe(offc) at the command of the deactivation controller offc provided by a user of the terminal. In particular, a user U of the terminal executing a process requests deactivation of the audio assistance by selecting the activation controller slct(offc). The deactivation exe(offc) then triggers the provision of the control interface rpr(ic+onc) for the executed process having the audio assistance activation controller by the processing method PT.

In a particular embodiment, the audio assistance method is implemented in the form of a program comprising program code instructions for executing the steps of the audio assistance method when the program is executed by a processor.

In a particular embodiment, the processing method is implemented in the form of a program comprising program code instructions for executing the steps of the processing method when the program is executed by a processor.

The present disclosure is aimed at the processes, also called services, that are accessible on the terminals, using control interfaces such as a digital interface, particularly a graphical or touch interface. It proposes an audio assistance method for the control interface for the process allowing the inexperienced user, particularly a user having reading difficulties: illiteracy, partial sight, etc., to explore the selection controllers of the interface by transmitting to him a piece of information on the subprocess associated with this selection controller through one of the descriptive audio data also called associated audio events (vocalization or sound, etc.) in order to guide him in the use of a service or a terminal.

The audio assistance method by replacing triggering of execution of a subprocess associated with a selection controller with triggering of an audio reproduction of descriptive data of the subprocess allows the initial action corresponding to an interaction element (or selection controller) not to be triggered.

The audio assistance method makes it possible to keep and not to clash with the principles of navigation initially defined in a process, more precisely in a control interface for the process (by clicking, dragging, pressing, etc.), by proposing activation/deactivation of assistance on the active interface for the process allowing toggling from the control interface for the process to an interface offering audio assistance for at least one controller (such as an audio assistance interface), and vice versa.

The audio assistance method makes it possible to keep direct access to the selection controller of the control interface associated with descriptive audio data without going through sequential listening to descriptive data from the other selection controllers of the control interface: indeed, the user can interact with the active interface offering audio assistance for at least one selection controller by using the initial scrolling rules for the process.

The assistance method proposes activation/deactivation of the audio assistance, particularly by means of an audio assistance interface, at any instant in the progress of the process rather than activation of overall tutorial type, that is to say a tutorial for the whole process rather than just for one of the controllers of the interface.

As the assistance method has not modified the scrolling rules but rather only the consequences of selection of a controller and provides an active interface offering audio assistance on the basis of the control interface, the active interface, such as the audio assistance interface, possibly appears in multiple windows allowing the quantity of information broadcast by one and the same window to be lightened. The passage from one window to the other is either automated (triggered automatically at the end of a predetermined period of time or at the end of a given step in the executed process, etc.) or triggered manually, for example by vertical or horizontal dragging, selection of a next/previous/indicated page, etc., as for the control interface.

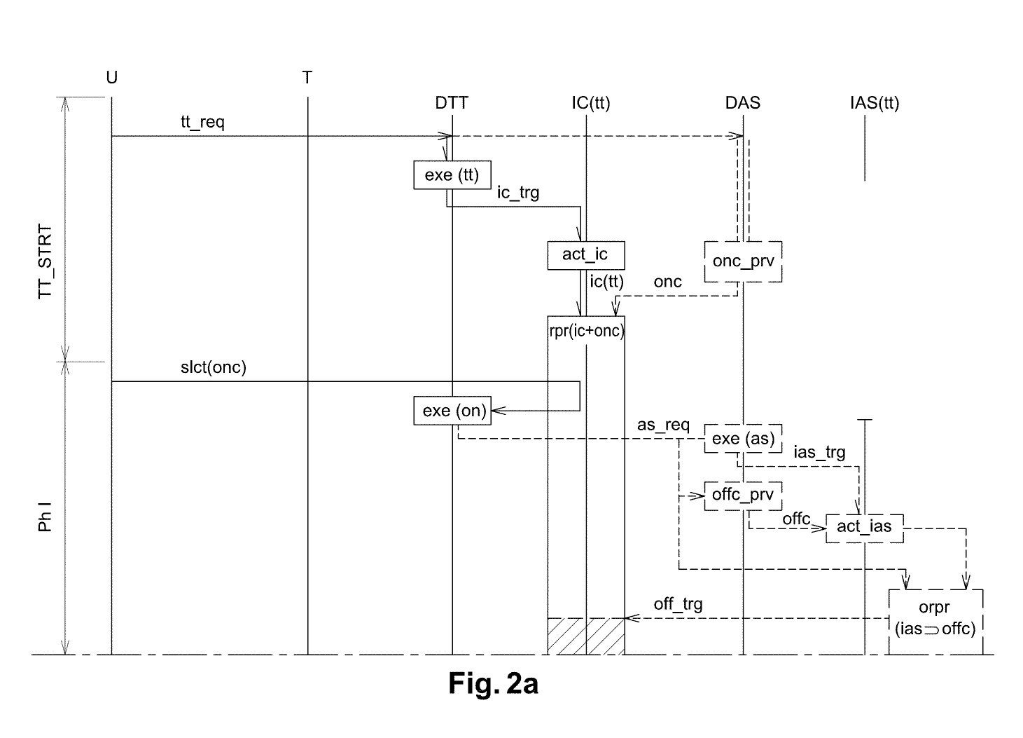

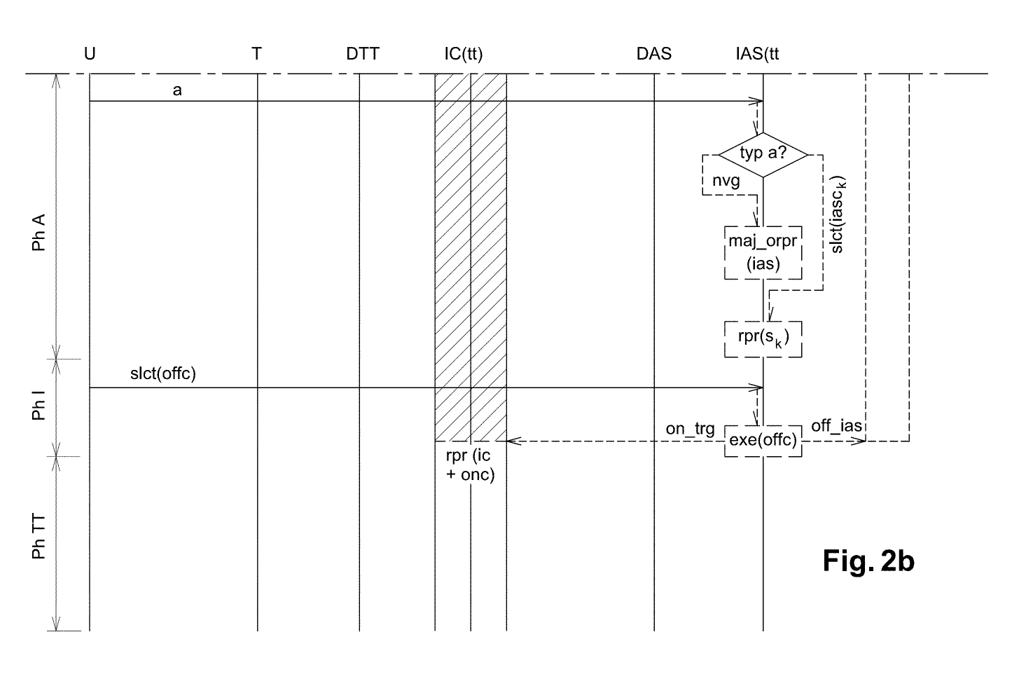

FIGS. 2a and 2b illustrate a simplified diagram of the exchanges in a terminal implementing the embodiments disclosed herein. The exchange diagram is split over the two FIGS. 2a and 2b. FIG. 2a has the exchanges at the time of start-up of the execution of a process by the terminal, at the time of the activation of the audio assistant.

A user U interacts with a terminal T by means of a control interface IC of the terminal T. The terminal T particularly has a processing device DTT, particularly a processor implementing a process tt. In the example of FIGS. 2a and 2b, the control interface IC is adapted to the process being executed tt: thus, the user U can interact with the processing device by means of a control interface specific to the process IC(tt). The present disclosure proposes that the terminal T moreover has audio assistance DAS. The user U interacts with the audio assistant DAS by means of an audio assistance interface adapted to the process being executed IAS(tt). Thus, on a terminal T offering multiple simultaneously executed processes tt₁ . . . ttₙ, the audio assistant DAS has an audio assistance interface through process, respectively IAS₁=IAS(tt₁) . . . IASₙ=IAS(ttₙ)—not illustrated.

FIG. 2a illustrates a first phase TT_STRT during which a processing device DTT of the terminal T is started up. A user U requests the implementation of a process tt_req particularly by selecting a selection controller of a control interface of the terminal T (not illustrated), particularly the launch of an application on a smartphone, or a tablet. The processing device DTT executes the process exe(tt), particularly a processor of the terminal executes the process. This triggers ic_trg the activation of a control interface adapted to the process act_ic. The control interface IC(tt) being activated act_ic particularly provides control interface data: by way of example, the association data adapted to the process between the selection controllers of the control interface IC of the terminal T and initiators of execution of subprocesss sstₖ of the executed process tt. The control interface IC(tt) then provides rpr(ic) a control interface adapted to the process being executed.

By way of example, the control interface is displayed on the screen of the smartphone with interface elements or selection controllers in the form of at least one of the following elements:
buttons,
menu labels,
information messages,
page headers, etc.

During this first phase, following the triggering tt_req of the execution of a process activating a control interface act_ic, the audio assistant DAS according to the disclosed embodiments provides an assistance activation controller onc_prv to the control interface IC(tt). The control interface IC(tt) then provides rpr(ic) a control interface adapted to the process being executed having an assistance activation controller.

Thus, for any process being executed, the control interface will offer a controller allowing the audio assistance to be activated. This avoids the user returning to the setting of the terminal in order to activate the audio assistance. As the audio assistance can be activated more simply, the assistance interface requires fewer controllers and therefore fewer resources in terms of calculations and storage.

In a second phase referred to as an activation phase Ph I, the user U requests activation of the assistance for the process being executed by using slct(onc) the activation controller one of the control interface IC(tt). By way of example, the user triggers the activation of the audio assistance by virtue of:
proximity and/or motion detection,
on the basis of the distance in relation to the screen (for example a partially sighted person getting closer to the screen in order to better distinguish the entries will trigger the activation of audio assistance, etc.),
breath detection (for example a user breathing on the screen in making efforts to read wordings for various reasons: partial sight, illiteracy, complexity of the process, etc., will trigger the activation of the audio assistance),
by virtue of selection of a dedicated selection controller or activation controller one (for example: button, etc.)

The processing device DTT executes the activation controller exe(onc) and requests the audio assistance as_req from the audio assistant DAS, which activates the audio assistance exe(as). The activation of the audio assistance exe(as) by the audio assistant DAS triggers the audio assistance interface ias_trg, which activates act_ias the audio assistance interface IAS for the process being executed.

In parallel, the audio assistance request as_req triggers the provision of an assistance deactivation controller offc_prv by the audio assistant DAS. The audio assistance DAS provides the assistance deactivation controller offc to the audio assistance interface IAS(tt).

The audio assistance interface IAS(tt) then provides orpr(ias⊃offc) an audio assistance interface adapted to the executed process, particularly by reproducing the audio assistance interface. This provision of the adapted audio assistance interface possibly triggers off trg the deactivation of the control interface IC(tt) for the executed process.

FIG. 2b has the exchanges when the audio assistant is active, at the time of and after stoppage of the audio assistant.

In a third phase referred to as active assistance Ph A, the interface awaits an interaction from the user. Next, when the user U performs an action a on the audio assistance interface IAS(tt), the audio assistance device carries out a task. Depending on the type of action type a?, the audio assistance device DAS carries out either an update to the provision of the audio assistance interface maj_orpr(ias) in the case of a scrolling action nvg, or an audio reproduction rpr(sₖ) of descriptive data sₖ associated with the controller in the case of a selection action slct(iascₖ).

In the case of the audio reproduction, the audio assistance device particularly calls for the libraries of audio events or for the assistance database, in which each selection control is associated with a triggering of an audio reproduction of descriptive data. This audio reproduction or audio event is either specific to the executed process or standard (that is to say common to multiple processes). Next, the audio assistance device reads the audio event, that is to say that it reproduces the descriptive data in audio fashion, possibly with an entry in a temporary memory (cache memory) of the terminal for the descriptive data so as not to have to look for them in the libraries if the user wishes to listen to them again during this assistance phase Ph A.

Thus, the audio assistance interface IAS proposes modification of the control interface IC solely for one or more selection controllers. For a scrolling action on the audio assistance interface IAS, the result will be scrolling in the requested direction, possibly the provision of the next or previous page of the audio assistance interface relative to the next or previous page of the control interface.

These steps can be repeated as many times as required by the user U for the various actions possible on the audio assistance interface IAS(tt) for as long as the audio assistance interface is active.

During a deactivation phase Ph I, a user U requests the deactivation of the audio assistance slct(offc) from the audio assistance interface IAS. The audio assistant DAS executes the deactivation exe(offc) stopping the provision orpr(ias) of the audio assistance interface IAS and, if need be, activating the provision rpr(ic+onc) of the control interface allowing the processing phase to be started up.

Like the activation, the deactivation can be triggered by proximity/distance and/or motion detection, distance detection in relation to the screen, breath detection or by the selection of a dedicated button (deactivation controller), etc.

The terminal is then in a processing phase Ph TT, during which the user can interact with the processing device DTT by means of the control interface IC according to the rules defined by the process.

The user U can reactivate and deactivate at will the audio assistance throughout the whole of the execution of each process executable by the terminal, thus making it possible to change, after a processing phase Ph TT, to an activation phase Ph I, an assistance phase Ph A, a deactivation phase, then a processing phase Ph TT again to an activation phase Ph I, an assistance phase Ph A, a deactivation phase, etc.

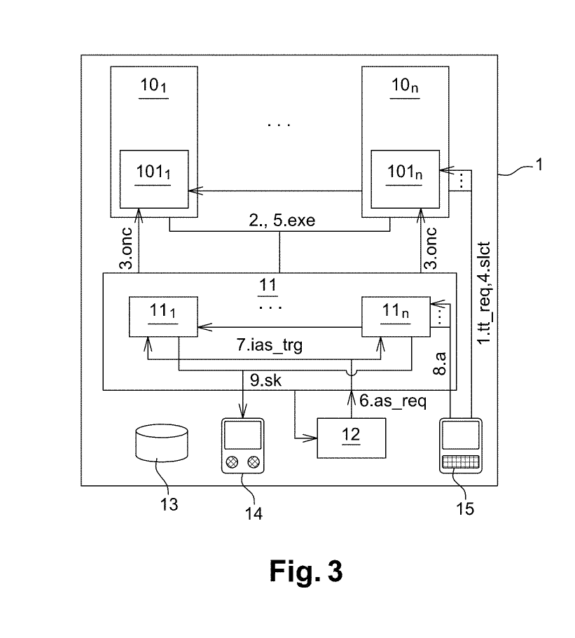

FIG. 3 illustrates a simplified diagram of a terminal having an audio assistant according to various embodiments.

The terminal 1 has:
a processor 12 executing at least one process;
at least one control interface 101₁ . . . 101ₙ for one of the at least one process; and
a control interface audio assistant 11, the audio assistance 11 providing, following the triggering of execution, by the terminal 1, of a process activating a control interface allowing a user of the terminal 1 to interact with the executed process, the active control interface with an assistance activation controller allowing the user of the terminal 1 to activate audio assistance adapted to the active control interface.

In particular, the terminal 1 has one or more processing devices 10₁ . . . 10ₙ. The processing device 10₁ . . . 10ₙ particularly triggers the execution of the process by the processor 12.

In particular, the audio assistant 11 has at least one audio assistance interface adapted to each process 11₁ . . . 11ₙ.

In particular, the terminal 1 has an input interface 15 such as a touchscreen, a keyboard, a mouse, etc., allowing control of the audio assistance interface adapted to each process 11₁ . . . 11ₙ.

In particular, the terminal has a reproduction interface 14 allowing provision of the control interface 101₁ . . . 101ₙ and of the audio assistance interface 11₁ . . . 11ₙ.

In particular, the terminal 1 has at least one memory 13 that stores the data of the control interfaces and/or of the audio assistance interfaces.

By way of example, the user uses the input interface 15 to request 1.tt_req the execution of a process that triggers the start-up of the corresponding processing device 10₁ . . . 10ₙ. The processing device 10₁ . . . 10ₙ activates the control interface 101₁ . . . 101ₙ. The start-up of the processing device 10₁ . . . 10ₙ, in particular the activation of its control interface 101₁ . . . 101ₙ, triggers 2. provision of an activation controller 3.onc by the audio assistant 11 to the control interface 101₁ . . . 101ₙ.

If the user uses the input interface 15 to select 4.slct the assistance activation controller one of the control interface 101₁ . . . 101ₙ, the control interface 101₁ . . . 101ₙ activates the audio assistance 5.exe.

The audio assistant 11 then provides an audio assistance interface 11₁ . . . 11ₙ adapted to the executed process. By way of example, the audio assistant 11 uses the processor 12 of the terminal 1 in order to implement the audio assistance and request 6.as_req the activation of the audio assistance by the audio assistant 11, which provides the audio assistance interface 7.ias_trg.

The user can then carry out an action 8.a relative to the audio assistance interface 11₁ . . . 11ₙ adapted to the executed process. This action 8.a triggers audio reproduction of the descriptive data 9.sₖ of the subprocess associated with the controller selected by the action, particularly by means of the reproduction interface 14 having at least one or more loudspeakers.

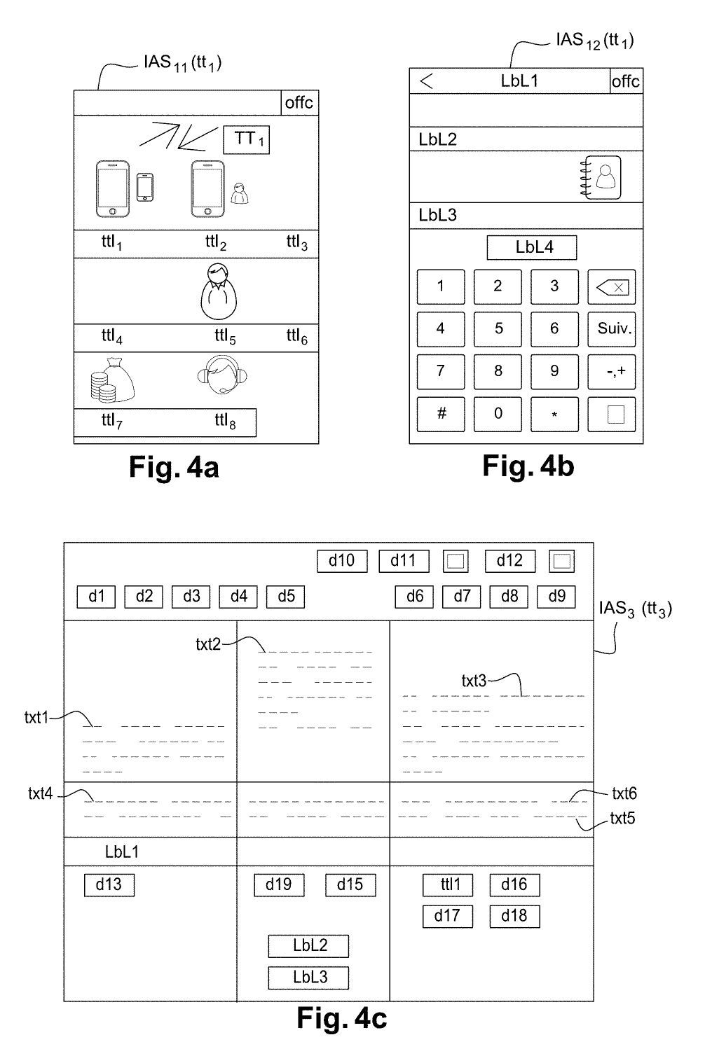

FIGS. 4a, 4b and 4c illustrate examples of audio assistance interfaces according to various disclosed embodiments. FIGS. 4a and 4b show two different pages of one and the same audio assistance interface for a process of application type for a smartphone.

The audio assistance method is implemented for the active control interface (generally the displayed control interface, or even the displayed window of the control interface). When the audio assistance is:
active: an audio assistance interface is superposed on the current window of the control interface and allows the user audio exploration of the various elements of the current window of the control interface, as are illustrated by FIGS. 4a to 4c;
inactive: the user interacts with a control interface for the process according to predefined initial rules of interaction (that is to say the associations between a selection controller and execution of an associated subprocess).

FIGS. 4a and 4b show two pages IAS₁₁ and IAS₁₂ of an audio assistance interface IAS1 for the same process tt₁. On these two pages IAS₁₁ and IAS₁₂, the audio assistance interface IAS1 has a deactivation controller offc. The audio assistance interface IAS1 is reproduced superimposed on the control interface for the process tt₁.

The selection controllers for which audio assistance is available are reproduced in non-veiled form, whereas the selection controllers for which audio assistance is not available are reproduced in veiled form.

Thus, the page IAS₁₁ provides audio assistance for 5 subprocesses called ttl₁, ttl₂, ttl₅, ttl₇, ttl₈ but not for the other 3 subprocesses of the control interface called ttl₃, ttl₄ and ttl₆.

Furthermore, the page IAS₁₂ provides audio assistance for 3 subprocesses designated lbl₁, lbl₂, lbl₃ but not for the subprocess designated lbl₄.

FIG. 4c illustrates an audio assistance interface IAS₃(tt₃) for an internet page displayed by a browser on a tablet or a computer. This page is made up of texts txt₁ . . . txt₆, denoted lbl₁, of titles ttl₁ and of descriptive data d₁ . . . d₁₈.

The selection controllers for which audio assistance is available are reproduced in boxed form (by, in particular, the selection controllers associated with the descriptive data d₁ . . . d₇, texts txt₁ . . . txt₃, etc.) in the knowledge that the control interface is veiled.

The assistance method is integrable into information access services, transaction, gaming, etc., interfaces for situations of use on roaming terminals (tablets, smartphone).

The present disclosure is also aimed at a non-transitory computer-readable medium. The non-transitory computer-readable medium may be any entity or device capable of storing at least one of the programs according to the embodiments disclosed herein. By way of example, the medium may have a storage means, such as a ROM, for example a CD ROM or a microelectronic circuit ROM, or else a magnetic recording means, for example a floppy disk or a hard disk.

On the other hand, the information medium may be a transmissible medium such as an electrical or optical signal that can be conveyed via an electrical or optical cable, by radio or by other means. The program according to the present disclosure may, in particular, be downloaded on a network particularly of Internet type.

Alternatively, the information medium may be an integrated circuit into which the program is incorporated, the circuit being adapted to execute or to be used in the execution of the method in question.

In another implementation, the embodiments disclosed herein are implemented by way of software and/or hardware components. With this in mind, the term module can just as well correspond to a software component or a hardware component. A software component corresponds to one or more computer programs, one or more subroutines of a program, or, more generally, to any element of a program or of a piece of software that is capable of implementing a function or a set of functions according to the above description. A hardware component corresponds to any element of a hardware assembly, such as a processor, that is programmed or configured to implement a function or a set of functions.

1. An audio assistance method for a control interface of a terminal, the audio assistance method comprising, following the triggering of execution, by the terminal, of a process activating a control interface allowing a user of the terminal to interact with the executed process, providing the active control interface with an assistance activation controller allowing the user of the terminal to activate audio assistance adapted to the active control interface.

2. The audio assistance method according to claim 1, the method comprising, following activation of audio assistance of an active control interface for a process executed by the terminal, providing an active interface for the executed process with an assistance deactivation controller allowing the user of the terminal to deactivate the audio assistance of the control interface for the executed process.

3. The audio assistance method according to claim 1, the method comprising, following activation of audio assistance, replacing, solely and at least for one of the selection controllers of the active control interface, triggering of execution of a subprocess associated with the selection controller of the active control interface with triggering of audio reproduction of descriptive data relating to the subprocess associated with the selection controller.

4. The audio assistance method according to claim 1, the method comprising generating an audio assistance interface from a modification solely of the selection controllers of the active control interface.

5. The audio assistance method according to claim 1, wherein generating an audio assistance interface for a control interface for a process is triggered as soon as at least one of the following events occurs: activation of audio assistance from a control interface for a process, installation of the audio assistance method on the terminal, installation of a process on the terminal, and update of a process on the terminal.

6. The audio assistance method according to claim 5, wherein the generating the audio assistance interface comprises storing in the terminal, in association with the process, the generated audio assistance interface, and allowing subsequent activation of the audio assistance for the control interface for the process to trigger the implementation of the audio assistance interface stored in association with the process.

7. The audio assistance method according to claim 1, the method comprising activating the audio assistance at the command of a user of the terminal triggering reproduction of an audio assistance interface for the process being executed, the audio assistance interface having been generated from a modification solely of the selection controllers of the active control interface.

8. The audio assistance method according to claim 1, the method comprising activation of the audio assistance at the command of a user of the terminal triggering reproduction of an audio assistance interface superposed on the reproduced active control interface, the audio assistance interface having been generated from a modification solely of the selection controllers of the active control interface.

9. The audio assistance method according to claim 1, wherein the control interface is at least one of a visual interface and a graphical interface.

10. A processing method configured to be executed by a terminal comprising a processor, the processing method comprising:
activating a control interface of a terminal to allow a user of the terminal to interact with the executed processing method; and
following a triggering of execution of the processing method by the terminal, providing the active control interface with an activation controller for audio assistance allowing the user of the terminal to activate audio assistance adapted to the active control interface.

11. A non-transitory computer-readable medium comprising program code instructions stored thereon for executing the steps of the audio assistance method according to claim 1 when the program code instructions are executed by a processor.

12. A computer terminal comprising:
a processor configured to execute at least one process;
at least one control interface for one of the at least one process; and
an audio assistant for a control interface, the audio assistance configured to provide, following a triggering of execution, by the terminal, of a process activating a control interface allowing a user of the terminal to interact with the executed process, the active control interface with an assistance activation controller allowing the user of the terminal to activate audio assistance adapted to the active control interface.
